(19) United States
(12) Patent Application Publication
(10) Pub. No.: US 2007/0020600 A1
(43) Pub. Date: Jan. 25, 2007

(54) Activity center

(76) Inventors: John White, Chicago, IL (US); Galina Treyer, Northbrook, IL (US); Matthew J. Gerules, Chicago, IL (US); Shauna Smith, Wheaton, IL (US); Kristin Anderson, Darien, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/184,674

(22) Filed: Jul. 19, 2005

(51) Int. Cl. G09B 5/00

(52) U.S. Cl. 434/317

(57) ABSTRACT

An activity center is provided that includes a case having an upper and lower shell hingedly joined together. The upper shell has a recessed portion disposed on a top surface that receives a writing surface that is hingedly joined to the top surface of the upper shell. The recessed portion is adapted to receive a paper or template including indicia between the top surface and the writing surface and the indicia on the paper or template is at least partially visible through the writing surface.

### BACKGROUND

1. Field of the Disclosure

The disclosure is generally related to laptop activity centers and specifically related to laptop activity centers that have an eraseable drawing surface.

2. Description of the Related Art

Compact activity centers that include art activities for children are known in the art. Most activity center systems include a myriad of art activities and have a great number of parts and pieces. Additionally, such activity centers generally create a large amount of debris as a result of the art work. Further, the potential exists for such systems to stain or otherwise discolor surrounding carpeting, tabletops, and other surfaces. For example, often with activity centers that include markers or paintbrushes, the child may color on furniture or other fixtures, thereby damaging these items. Moreover, whenever a children's toy includes many pieces, often, several of the pieces will become lost over time.

Most often, the problems encountered with these activity center systems include a large and bulky case, too many pieces and lack of easy clean up.

### SUMMARY OF THE DISCLOSURE

An activity center is provided that includes a case having an upper and lower portion hingedly joined at one edge thereof. A writing surface is hingedly engaged with the upper housing portion and a recessed portion is disposed on the top surface of the upper housing portion. The case also includes at least one writing instrument securement well provided in the upper housing portion.

### BRIEF DESCRIPTION OF THE DRAWINGS

FIG. 1 is a perspective view of an activity center constructed in accordance with the present disclosure;

FIG. 2 is a fanned perspective view of the activity center of FIG. 1; and

FIG. 3 is a perspective cross section taken along line 3-3 of FIG. 1.

### DETAILED DESCRIPTION

Generally, an activity center includes a case having a top and bottom shell pivotably joined together. The top shell includes a central recessed portion, a writing surface and a well. The well is formed in the top shell and is adapted to store writing utensils. A lid generally covers the well. The top and bottom shells form a storage compartment adapted for storing templates, sheets of paper and the like.

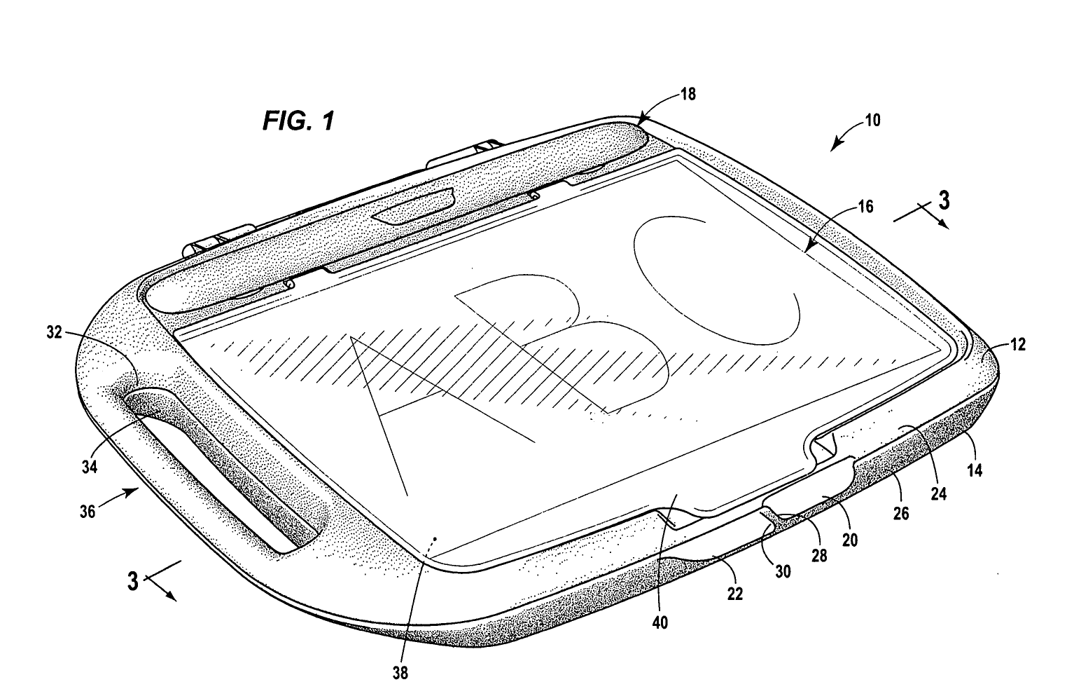

FIG. 1 illustrates an activity center 10 in a perspective view. The activity center 10 includes an upper shell 12 and a lower shell 14, hingedly joined together along rear edges thereof. The upper shell 12 is generally planar and includes a center recessed portion 16 and a well 18. Opposite the hinge, both the upper and lower shells 12, 14 include flanges 20, 22 extending generally outward from the outer surface of front walls 24, 26 thereof. These flanges 20, 22 are complementary in shape along adjacent edges 28, 30 and when the upper and lower shells 12, 14 are in a closed position, the flanges 20, 22 lie in substantially the same plane and adjacent one another along the edges 28, 30 thereof. The flanges 20, 22 provide surfaces used to separate the upper and lower shells exposing a storage space (not shown in FIG. 1) therein. In a manner similar to opening a coin purse, a user may grasp the flanges 20, 22 in different hands and push the flanges 20, 22 in opposite directions with sufficient force to expose the storage space.

Both the upper and lower shells 12, 14 may include openings 32, 34 along one side wall thereof. These openings 32, 34 align with each other when the upper and lower shells 12, 14 are in the closed condition forming a handle 36. The handle 36 may be used to carry the activity center 10 when the upper and lower shells 12, 14 are closed.

The center recessed portion 16 is generally sized and shaped to receive a sheet of paper or a template 38 in a generally horizontal position, bearing indicia thereon. Additionally, a writing surface 40 is hingedly joined to the upper shell 12 between the center recessed portion 16 and the well 18. The writing surface 40 is generally transparent. However, the writing surface 40 may be translucent or tinted as long as the template or paper 38 disposed in the center recessed portion 16 is visible through the writing surface 40. Furthermore, the writing surface 40 may be generally colorless or may be tinted with any color as long as it is transparent or sufficiently translucent to view the indicia on the paper or template 38 received in the center recessed portion 16.

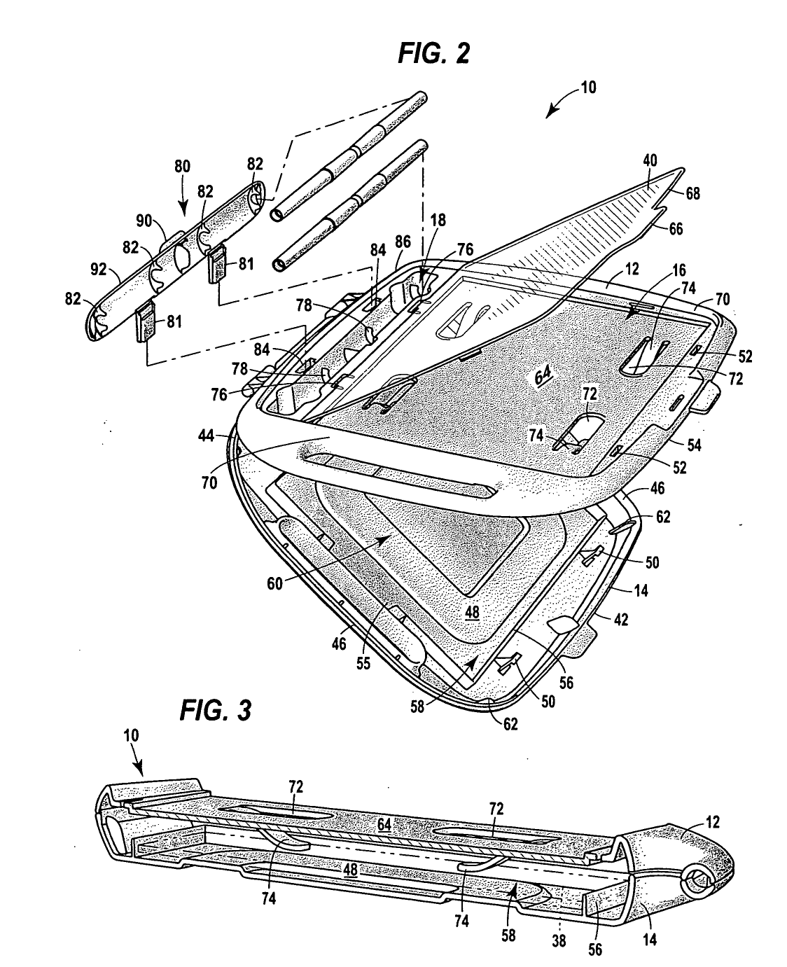

In FIG. 2, the activity center 10 is shown in a generally open and fanned condition. The lower shell 14 is generally tray-shaped and includes front and rear walls 42, 44 and a pair of generally opposed and spaced apart side walls 46. Additionally, the lower shell 14 includes a base panel 48. A plurality of fingers 50 project generally upward, away from the base panel 48. These fingers 50 include latches at a distal end thereof and are sized and shaped to be received by latch slots 52 formed in the upper shell 12 proximate a front edge 54 of the upper shell 12. The fingers 50 and slots 52 cooperate to provide a releasable lock for the case. A fence 56 also extends generally upward, away from the base panel 48 and forms a retention area 58 for storing templates, papers or the like 38 within the storage area 60. The fence 56 may have a gap 55 in one or more sides thereof to facilitate a user removing the papers or templates 38 from the retention area 58. Various ribs 62 or other strengthening features may be added to the lower and upper shells 12, 14 to enhance the rigidity of the upper and lower shells 12, 14.

The center recessed portion 16 of the upper shell 12 is approximately the same size as the retention area 58 of the lower shell 14. The center recessed portion 16 is sized and shaped to receive a paper or template 38 adjacent a mounting surface 64 of the center recessed portion 16. The writable surface 40 overlays the center recessed portion 16 thereby securing the paper or template 38 within the center recessed portion 16. The writable surface 40 is hinged to the upper shell 12 between the center recessed portion 16 and the well 18. Additionally, the writable surface 40 includes a tab 66 extending from a front edge 68 of the writable surface 40. This tab 66 provides a gripping or lifting surface and aids in raising and lowering the writable surface 40.

The mounting surface 64 is angled towards the front edge 54 of the upper shell 12. This feature gently angles the paper or template 38, and thus the writing surface 40, towards the user making writing on the writing surface 40 and viewing the paper or template 38 easier. Additionally, when the writing surface 40 is in the closed position, side walls 70 of the upper shell 12 extend to an elevation above that of any portion of the writing surface 40. The side walls 70 of the upper shell 12 provide a physical barrier at the edges of the writing surface 40, thus reducing the chance of inadvertent marks being caused by the writing instrument falling off of the writing surface 40. The central recessed portion 16 includes a plurality of openings 72 disposed in therein. The openings 72 each include a downward extending flexible tongue 74. The flexible tongues 74 are generally elongate in shape and extend downward, into the storage space 60 formed between the upper and lower shells 12, 14. The upper shell 12 includes two slots 76 between the central recessed portion 16 and the well 18 that form a part of a hinge for the writable surface 40.

The well 18 is adapted for storing writing instruments therein. The well 18 includes a plurality of ribs 78 disposed along inner walls thereof. The plurality of ribs 78 form holding surfaces for marker type pens or other writing instruments. A generally elongate well cover 80 includes a pair of hinge extensions 81 along one end thereof for hingedly connecting the well cover 80 to the case. The well cover 80 may be translucent or transparent to allow a user to discern if a writing utensil is disposed within the well 18. Of course, the well cover 80 may be opaque if desired. The well cover 80 also includes a plurality of ribs 82 extending from the bottom side thereof, that are similar to the ribs 78 disposed in the well 18 for removably mounting writing instruments. The ribs 82 are configured to accept the writing instruments bi-directionally in a longitudinal orientation. Additionally, the upper shell 12 includes a plurality of slots 84 in the upper surface thereof between the well 18 and a back edge 86. These slots 84 are sized and shaped to receive and support the hinge extensions 81 on the well cover 80. The hinge extensions 81 are removably disposed in the slots 84 with a snap-fit type arrangement and function as living hinges allowing the well lid 80 to be bent at the living hinge to a closed position that substantially covers and secures the well 18. A tab 90 extends generally outward from the front edge 92 of the well cover 80 to facilitate moving the well cover 80 to the open position.

FIG. 3 is a cross section of the activity center taken along line 3-3 of FIG. 1. In this view, the tongues 74 flexibly secure a paper or template 38 (shown in phantom) within the retaining area 58 of the lower shell 14. The tongues 74 flex upward, towards the upper shell 12 to accommodate more than one template 38 or templates 38 of different thicknesses. In this manner, the tongues 74 secure the papers or templates 38 within the case thereby preventing any damage and/or shifting of the papers or templates 38. Also evident in this view is the overall compact, thin shape of the activity center 10 in the closed condition. This feature makes the activity center easy to transport and store.

While certain embodiments have been described herein, it will be understood that variations may be made that are within the scope of the appended claims.

What is claimed is:

1. An activity center comprising:
a case having an upper portion and a lower portion hingedly joined at one edge thereof;
a writing surface hingedly engaged with the upper portion;
a recessed portion disposed on a top surface of the upper portion; and
at least one writing instrument securement well provided in the upper portion.

2. The activity center of claim 1, wherein the at least one writing instrument securement well is disposed on the upper portion of the case adjacent the recessed portion.

3. The activity center of claim 1, wherein a securement well cover is hingedly joined to the upper portion of the case to selectively cover the writing instrument securement well.

4. The activity center of claim 3, wherein the securement well cover is translucent.

5. The activity center of claim 3, wherein the securement well cover is joined to the upper housing portion with a living hinge.

6. The activity center of claim 3, wherein the securement well cover includes a plurality of ribs extending from an underside thereof adapted to securely receive a writing instrument.

7. The activity center of claim 6, wherein the ribs mount the writing instrument bi-directionally.

8. The activity center of claim 3, wherein a stop limits the angular displacement of the writing surface to a position at which the writing surface does not interfere with access to the securement well.

9. The activity center of claim 3, wherein the securement well includes a plurality of ribs extending from an inner surface thereof and wherein the ribs are configured to mount a writing instrument.

10. The activity center of claim 1, wherein the recessed portion includes a generally planar bottom surface adapted to receive a template.

11. The activity center of claim 10, in combination with an indicia-bearing template received in the recessed portion, said indicia being visible through the writing surface.

12. The activity center of claim 10, wherein the bottom surface is angled.

13. The activity center of claim 12, wherein the bottom surface is further from the bottom portion near the rear edge of the bottom portion than near the front edge of the bottom portion.

14. The activity center of claim 1, wherein the upper and lower portions each include a flange extending outwardly therefrom.

15. The activity center of claim 14, wherein the flanges are parallel and adjacent to one another along one edge of the flanges.

16. The activity center of claim 1, wherein the writing surface is transparent.

17. The activity center of claim 1, wherein the writing surface is translucent.

18. The activity center of claim 1, wherein the writing surface is tinted.

19. The activity center of claim 1, wherein the upper portion includes a plurality of flexible tongues extending inwardly, towards a storage space defined between the upper and lower portions.

20. An activity center comprising:
a case including a lower shell having a base panel;
an upper shell hingedly mounted to the lower shell, the upper shell and lower shell defining a storage compartment;
a mounting surface provided on a side of the upper shell opposite the lower shell, said mounting surface adapted to receive a template thereon; and
a writing surface hingedly mounted to the case.

21. The activity center of claim 20, in combination with at least one indicia-bearing template received on the mounting surface, and said indicia being at least partially visible through the writing surface.

22. The activity center of claim 20, further including at least one writing instrument securement well provided in the case, said well disposed in the upper shell and being accessible when the writing surface is in a closed position overlying the mounting surface of the upper shell.

23. The activity center of claim 22, further including a cover associated with the at least one writing instrument securement well.
